(19) United States
(12) Patent Application Publication
(10) Pub. No.: US 2024/0383074 A1
(43) Pub. Date: Nov. 21, 2024

(54) METHOD OF MARKING A SOLID-STATE MATERIAL, MARKINGS FORMED FROM SUCH METHODS AND SOLID-STATE MATERIALS MARKED ACCORDING TO SUCH A METHOD

(71) Applicant: Master Dynamic Limited, Hong Kong (CN)

(72) Inventors: Yau Chuen YIU, Hong Kong (CN); Ka Wing Cheng, Hong Kong (CN); Koon Chung Hui, Hong Kong (CN)

(73) Assignee: Master Dynamic Limited, Hong kong (CN)

(21) Appl. No.: 18/417,804

(22) Filed: Jan. 19, 2024

Related U.S. Application Data
(63) Continuation of application No. 17/624,325, filed on Sep. 15, 2022, now abandoned.

(30) Foreign Application Priority Data
Jul. 2, 2019 (HK) 19126202.1

(51) Int. Cl. B23K 26/359; B23K 26/06; B23K 26/0622; B23K 26/08; B23K 26/082; G06V 20/80

(52) U.S. Cl. CPC B23K 26/359; B23K 26/0624; B23K 26/0643; B23K 26/0648; B23K 26/082; B23K 26/0861; G06V 20/80

(57) ABSTRACT

A process of forming a non-optically detectable authentication marking (210,320, 410,535) in a diamond (200,300). Authentication marking (210,320,410,535) is formed adjacent the outer surface of an article formed from a diamond material having intrinsic optical centers. Method includes the step of applying an image of predesigned authentication marking (210,320,410,535) to a region (201,310,530) of a diamond (200,300) at or adjacent the surface of the diamond (200,300) by way of a direct laser writing; wherein the fluorescence background of the diamond material from intrinsic optical center is suppressed by authentication marking (210,320, 410, 535) under fluorescent imaging, such that the non-optically detectable identifiable authentication marking (210,320,410,535) is viewable against the fluorescence background at the region (201,310,530) of the diamond (200,300) where the authentication marking (210,320,410,535) is applied.

### CROSS-REFERENCE TO RELATED APPLICATIONS

This is a continuation application of U.S. application Ser. No. 17/624,325 entitled “METHOD OF MARKING A SOLID-STATE MATERIAL, MARKINGS FORMED FROM SUCH METHODS AND SOLID-STATE MATERIALS MARKED ACCORDING TO SUCH A METHOD” filed on Dec. 31, 2021, which is a U.S. national phase of PCT International Application No. PCT/CN2020/104582 entitled “METHOD OF MARKING A SOLID-STATE MATERIAL, MARKINGS FORMED FROM SUCH METHODS AND SOLID-STATE MATERIALS MARKED ACCORDING TO SUCH A METHOD” filed on Jul. 24, 2020, which claims the right of priority to Hong Kong Application No. HK 19126202.1 filed on Jul. 2, 2019 the contents of which are incorporated in their entireties herein.

### TECHNICAL FIELD

The present invention relates to the field of marking of solid state materials, and more particularly to the marking of gemstones including diamonds.

### BACKGROUND OF THE INVENTION

Gemstone identification and grading has been long-established by international standards laboratories including GIA, IGI, Gem-A and NGTC. The identification and grading result is typically stored in an electronic media such as hard-disks, tapes, compact discs and the like, and a paper certificate is issued along with the corresponding gemstone.

When the certificate is lost, or when the gemstone is mixed with other gemstones, the identity of the gemstone is lost, and is required to be recertified.

The direct marking of gemstones including diamonds is a generally straight-forward method to avoid such circumstance and allows for re-identification.

Conventional techniques within the art for the marking of gemstones including diamonds include laser marking and ion beam marking.

However, when using laser marking, this can generate coarse patterns and leave unrecoverable ablation marks on the gemstone, causing permanent damage and can devalue the gemstone.

When using ion beam marking, such a technique can be used to inscribe fine patterns on the surface of the gemstone which can be 1000 times smaller than those using laser marking, however the process is typically relatively slow and requires precision.

Other than item identification, gemstone marking can provide traceability of an item such that its origin, its owner, and its features and the like. Such marking techniques can also assist in the prevention of the counterfeiting of precious articles such as artworks or jewellery, and be of assistance in the incident of theft.

### OBJECT OF THE INVENTION

It is an object of the present invention to provide a process for the marking of solid state materials, including gemstones and an identification marking which overcomes or at least partly ameliorates at least some deficiencies as associated with the prior art.

### SUMMARY OF THE INVENTION

The present invention relates to a process for the authentication of gemstones, in particularly of diamond, and for which authentication marking which is invisible to the naked eye.

The present invention provides for provision of an authentication mark in/on diamond and corresponding fabrication method, which satisfies at least the following requirements within the field of diamond authentication, these being:
(i) a truly invisible acquired authentication mark in/on diamond, which cannot be readily or easily removed;
(ii) a truly invisible acquired authentication marking in/on diamond which satisfies the requirements of diamond owners and industry, who do not want to see any artificial marking in/on their diamond.

The transferred authentication marking can only be observed by using a fluorescence imaging method at the suppressed area where the marking is applied, and a darkened part in an acquired image corresponding to the authentication marking.

In a first aspect, the present invention provides a process of forming a non-optically detectable authentication marking in a diamond, said marking being formed adjacent the outer surface of an article formed from a diamond material having intrinsic optical centers and said method including the step of: applying an image of predesigned authentication marking to a region of a diamond at or adjacent the surface of the diamond by way of a direct laser writing;
wherein the fluorescence background of the diamond material from intrinsic optical center is suppressed by said marking under fluorescent imaging, such that the non-optically detectable identifiable marking is viewable against the fluorescence background at the region of the diamond where the marking is applied.

The marking may be applied via a positive image imprinting approach.

The diamond includes optical centers for providing fluorescence.

The process is achieved by a direct laser writing process, using a pulsed laser.

The effective laser wavelength range is preferably from 300 nm to 400 nm.

The pulsed laser may be femtosecond, picosecond, or nanosecond laser.

The pulsed laser is preferably focused onto/into diamond by an oil immersed 100× NA 1.46 objective lens.

The direct laser writing process may be achieved by sample scan or Galvano mirror scan.

The sample scan may be achieved by placing the diamond on a 3 dimensional movable stage and moving the diamond 3 dimensionally with respect to a stationary laser spot. The 3 dimensional movable stage can be a motor-based or piezo-based.

The Galvano mirror scan may be achieved by placing the diamond on a stationary stage and a moving laser spot scanning over/within diamond.

The laser motion may be achieved by a Galvano mirror system.

The fluorescence of the part on/in diamond is removed after the direct laser writing process, the removal of fluorescence can be depletion of optical centers or shift of impurities.

The removal of fluorescence do not exert polycrystal effect to the diamond.

The removal of fluorescence do not exert nonlinear optical effect to the diamond.

The authentication marking is invisible to naked eye.

The authentication marking is invisible to naked eye under magnification.

The authentication marking is invisible in reflection, transmission, or polarized observation methods.

The authentication marking is visible using a fluorescence observation method.

The authentication marking is optically visible under a fluorescence method, and wherein the authentication marking is represented by a darkened portion of an image of the diamond by contrast to the fluorescent background of the diamond.

the authentication marking is revealed from the part on/in diamond with no/low fluorescence in a predesigned pattern, which is representative of the authentication marking.

In a second aspect, the present invention provides a non-optically detectable authentication marking, wherein said marking is provided at or adjacent the surface of a diamond by the process according to the first aspect.

In a third aspect, the present invention provides a diamond having an authentication marking applied thereto by a process according to the first aspect.

In a third aspect, the present invention provides a process of viewing a non-optically detectable authentication marking on a diamond according to the first aspect, said process including the steps of:
(i) providing a diamond having an authentication marking applied thereto according to the third aspect; and
(ii) viewing said diamond using a fluorescence imaging method;
   wherein the fluorescence background of the diamond material from intrinsic optical center is suppressed by said marking under fluorescent imaging, such that the non-optically detectable identifiable marking is viewable against the fluorescence background at the region of the diamond where the marking is applied.

### BRIEF DESCRIPTION OF THE DRAWINGS

In order that a more precise understanding of the above-recited invention can be obtained, a more particular description of the invention briefly described above will be rendered by reference to specific embodiments thereof that are illustrated in the appended drawings. The drawings presented herein may not be drawn to scale and any reference to dimensions in the drawings or the following description is specific to the embodiments disclosed.

The accompany drawings illustrate the present invention and explain its principle.

In the drawings, like reference numbers refer to like parts throughout:

FIG. 1 shows a reflection image of the diamond taken by a camera on conventional smart phone wherein the diamond has had a marking according to the present invention applied on a round brilliant cut HPHT diamond;

FIG. 2 shows a 488 nm CW laser exited single photon reflection image of a round brilliant cut HPHT diamond corresponding to the one shown in FIG. 1 and having been treated with method of the present invention taken by Carl Zeiss LMS 880 confocal laser scanning microscope of the diamond of FIG. 1;

FIG. 3 shows a 488 nm CW laser exited single photon fluorescence image of the diamond corresponding to the one shown in FIG. 1 taken by Carl Zeiss LMS 880 confocal laser scanning microscope of the diamond of FIG. 1 and FIG. 2;

FIG. 4 shows 760 nm Pulsed laser excited multiphoton fluorescence image of the diamond corresponding to the one shown in FIG. 1 taken by Carl Zeiss LMS 880 confocal laser scanning microscope of the diamond of FIG. 1, FIG. 2 and FIG. 3; and

FIG. 5 shows a comparison between FIGS. 1 to 4.

### DETAILED DESCRIPTION OF THE DRAWINGS

In order that a more precise understanding of the above-recited invention can be obtained, a more particular description of the invention briefly described above will be rendered by reference to specific embodiments thereof that are illustrated in the appended drawings. The drawings presented herein may not be drawn to scale and any reference to dimensions in the drawings or the following description is specific to the embodiments disclosed.

The present invention provides for a truly invisible acquired authentication marking in/on diamond fricated through an approach by removal of fluorescence from original diamond.

Diamonds have intrinsic optical centers (N3, H3, and NV center, etc.) at the surface and in the bulk of the diamond material. The intrinsic optical centers of a diamond are strongly fluorescent.

The present invention utilises such fluorescent characteristics for marking identification of diamonds.

Any externally introduced fluorescent authentication marking may thus immersed in this naturally vivid fluorescence background of the diamond comprised of intrinsic optical centers.

By turning off this fluorescence background thus provides a unique and internally effectively frozen authentication marking to diamond.

This turning off of the fluorescence background is achieved by using direct laser writing process.

In accordance with the invention, the diamond undergoes a processed and is irradiated by a pulsed UV laser.

The fluorescence of the irradiated part of the diamond is thus removed by the laser.

A negative image of predesigned authentication marking which is determined by a pathway or geometric shape is the then transferred to the diamond because the laser is scanning over/within the diamond in a desired area of interest where the marking is to be applied.

The transferred authentication marking is a suppression or interruption of the colour centers, which cannot be observed by conventional optical method, for example reflection image and transmission image or the like. Thus the marking is optically invisible even at high magnifications.

The transferred authentication marking can only be observed by using a fluorescence imaging method at the suppressed area where the marking is applied, and a darkened part in an acquired image corresponding to the authentication marking.

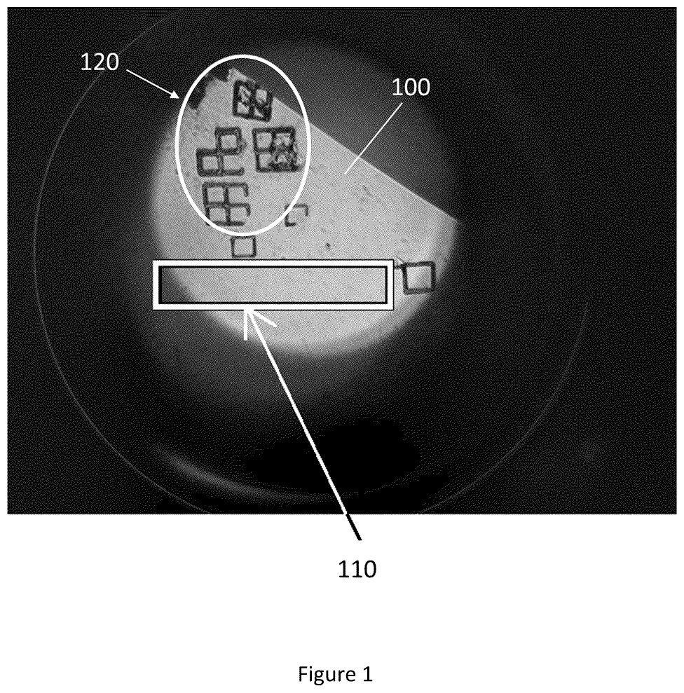

Referring to FIG. 1, there is shown a reflection image of the diamond 100 taken by a camera on conventional smart phone wherein the diamond has had a marking applied thereto according to the present invention applied on a round brilliant cut HPHT diamond.

It is noted that the authentication marking of the present invention is located within the enclosed area region 110 as shown in FIG. 1. However, when the marking is observed by a conventional optical method, which in this embodiment is a reflection image, the authentication marking 110 is optically invisible. As such, no marking can been seen in region 110 and thus, is considered invisible or non-optically detectable.

The optically invisible feature of the marking allows itself to not interfere with the optical properties of the diamond and thus the grading and value thereof when viewed under normal lighting conditions, yet advantageously still provides an non-removable identification to the diamond.

By contrast, it can be shown that markings 120 which are provided by conventional marking methods such as is known in the art are clearly visible when observed in a reflection image.

Having an optically visible marking under normal lighting conditions may provide a loophole in security as this allows counterfeiters to easily copy the identification marking, or if the marking is superficial to the diamond surface, remove it and possibly replace it with another marking.

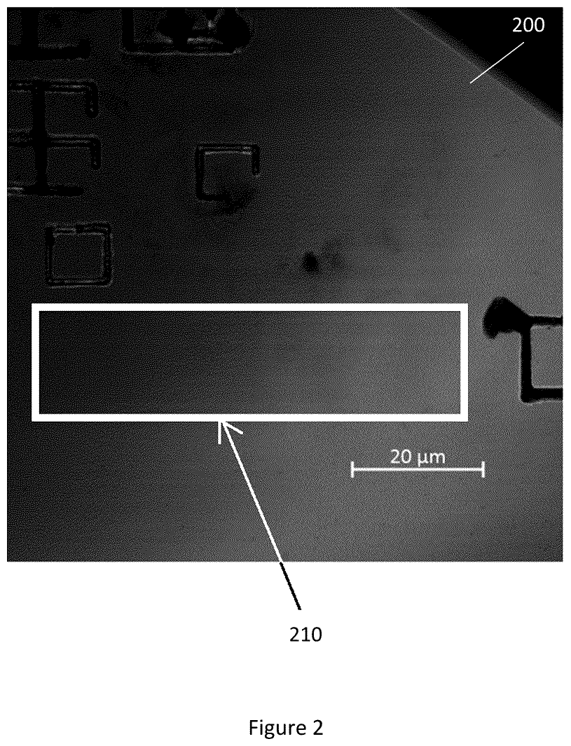

Referring to FIG. 2, there is shown a 488 nm CW laser exited single photon reflection image of the round brilliant cut HPHT diamond 200 of FIG. 1, having been treated with method of the present invention taken by Carl Zeiss LMS 880 confocal laser scanning microscope.

Still, as is shown in FIG. 2, the authentication marking located within the enclosed area region 201 is optically invisible when observed in a CW laser exited single photon reflection image. Further, although FIG. 2 has a higher magnification than that of FIG. 1, the marking remains to be optically invisible.

Since the authentication marking of the present invention is only a suppression or interruption of the colour centers of the diamond, the marking 210 remains optically transparent even at high magnifications unless a fluorescence imaging method is utilized for observation in accordance with the present invention.

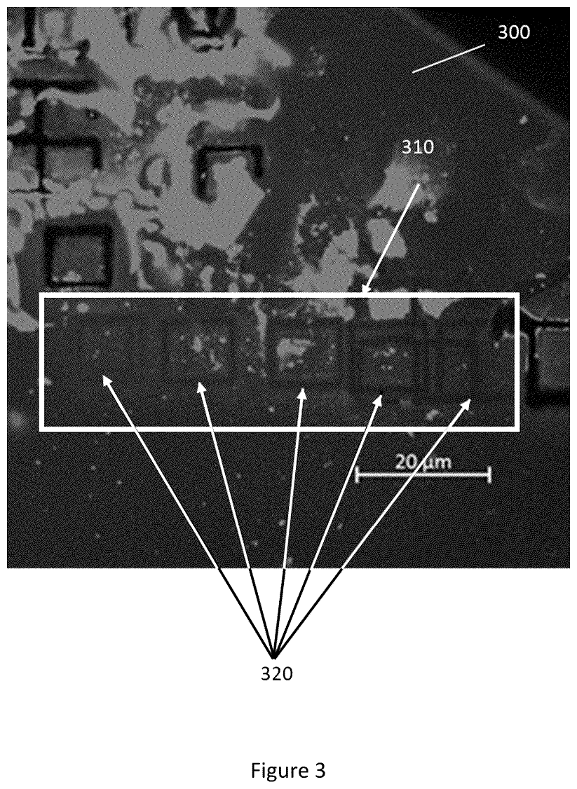

Referring to FIG. 3, there is shown a 488 nm CW laser exited single photon fluorescence image of the diamond 300 corresponding to the one shown in FIG. 1 and Figure taken by Carl Zeiss LMS 880 confocal laser scanning microscope of the diamond of FIG. 1.

This time, when the diamond 300 bearing a marking 320 of the present invention is observed under fluorescence imaging, the authentication marking 320 in region 310 written by laser appears to be darker than any other portions of the diamond 300 without a marking, and thus visible to the observers.

This is due to the fact that when the diamond is marked by the irradiation of a pulse UV laser, the intrinsic optical centers which bear the fluorescence characteristics of the marked portion 320 of the diamond are suppressed by the laser. The marked portion 320 has lost the fluorescence ability after irradiated by a UV laser and therefore it remains dark when observed under florescence imaging, while other portions of the diamond are strongly fluorescent.

As such, a negative image of the applied marking 315 is formed on the outer surface of the diamond 300, as provided by the present invention.

As is clearly evident, the fluorescence background of the diamond 300 material from intrinsic optical center is suppressed by the marking 320 under fluorescent imaging, such that the non-optically detectable identifiable marking is viewable against the suppressed fluorescence background at the region of the diamond where the marking is applied.

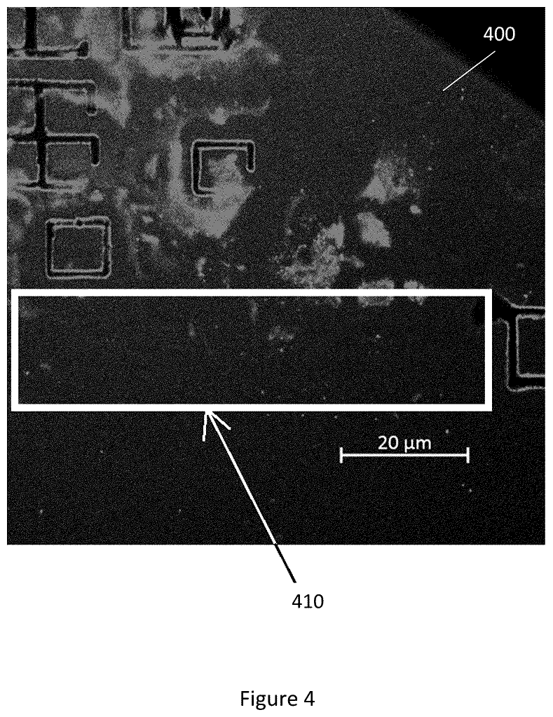

Referring now to FIG. 4, there is shown 760 nm Pulsed laser excited multiphoton fluorescence image of the diamond corresponding to the one shown in FIG. 1, FIG. 2 and FIG. 3 taken by Carl Zeiss LMS 880 confocal laser scanning microscope of the diamond of FIG. 1.

The Authentication marking 410 is invisible within a laser excited multiphoton fluorescence image as shown in FIG. 4.

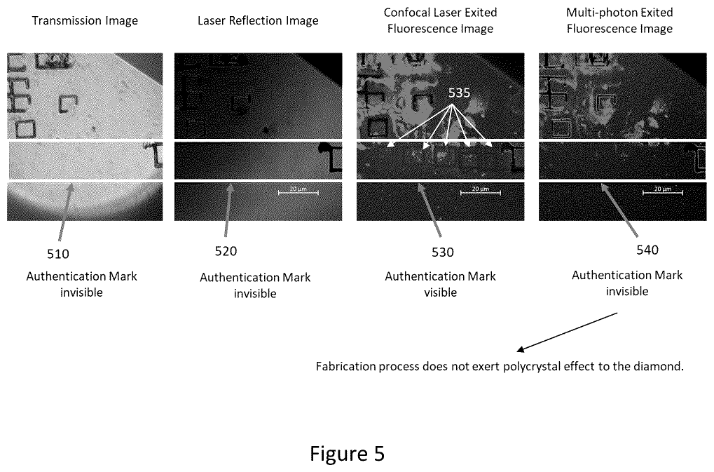

Now referring to FIG. 5, there is shown a comparison of FIGS. 1 to 4 and the image results, whereby the marking has been applied in the rectangular region. As can be seen, the non-optically detectable authentication marking is only viewable with the confocal laser excited fluorescence.

It can be shown that the only visible marking within FIG. 5 is the authentication marking 535 when viewed under confocal laser excited fluorescence in region 530.

The marking in corresponding 510, 520 and 540 in a transmission image, a laser reflection image or a multiphoton excited fluorescence image are transparent and not visible to the observers.

Thus the authentication marking 535 can only be observed by using a fluorescence imaging method at the suppressed area where the marking is applied, and a darkened part in an acquired image corresponding to the authentication marking.

Particular advantages of the present invention include:
providing a marking that is truly optically invisible, and
providing a marking that is irremovable.

Such advantages provide enhanced security, and provides significant technical impediments for the reproduction of the marking and as such, provides enhanced anti-counterfeiting attributes.

The marking method and marking from such method of the present invention provides the following further advantages:
(i) a marking which is not unsightly and which may not be readily viewed;
(ii) a marking which, when applied to articles such as precious stones or gemstones, allows for the identification for security purposes as well as tracking and origin of the articles;
(iii) security purposes, which may be utilized to mitigate or identify counterfeiting, and impropriety including theft and the like;
(iv) marking of a solid-state material, without the disadvantages associated with other destructive and invasive methods of marking such as ablation, milling, engraving and the like;
(v) a methodology and product thereof which does not alter the optical qualities or properties of a solid-state material, and which is not detrimental the clarity or colour of the solid-state material;
(vi) a methodology and product thereof, which does not introduce contaminants or impurities to the solid-state material;
(vii) a methodology and product thereof that requires no significant removal of material from the surface of the solid-state material; and
(viii) a methodology and product thereof, having no associated chemical residue.

It should be noted and understood that the embodiments of the present invention illustrate the idea and principle, not limitation. In these embodiments the methodology and the implementation mechanism may be modified or substituted for an efficient presentation without departing from the scope of the invention.

Thus, the appended claims are not to be limited by the embodiments.

The term “marking” is used throughout the description and claims, and such a “marking” will be understood by those skilled in the art to pertain to a “mark” provided at or adjacent the surface of an article, and the terms are synonymous with each other and may be used interchangeably without alteration of meaning or interpretation.

1. A process of forming a non-removable non-optically detectable authentication marking in a diamond, said marking being formed adjacent to an outer surface of an article formed from a diamond material having intrinsic optical centers and said method including the step of:
applying an image of predesigned authentication marking to a region of a diamond at or adjacent the surface of the diamond by way of a direct laser writing process using a pulsed laser having an effective laser wavelength range from 300 nm to 400 nm;
wherein the diamond material has a fluorescence background from said intrinsic optical center and wherein said fluorescence background is suppressed by said marking under fluorescent imaging, such that the non-optically detectable authentication marking is viewable against the fluorescence background at the region of the diamond where the marking is applied; and wherein the marking is non-removable.

2. The process according to claim 1, wherein the marking is applied via a positive image imprinting approach.

3. The process according to claim 1, wherein the diamond includes optical centers for providing fluorescence.

4. The process according to claim 1, wherein the laser writing process is by way of femtosecond, picosecond, or nanosecond laser writing process.

5. The process according to claim 4, wherein the direct laser writing process is achieved by sample scan or Galvano mirror scan.

6. The process according to claim 1, wherein the fluorescence of the part on/in diamond is removed after the direct laser writing process at the marking.

7. The process according to claim 6, wherein the removal of fluorescence is depletion of optical centers or shift of impurities, wherein the removal of fluorescence preferably does not exert polycrystal effect to the diamond, and wherein the removal of fluorescence preferably does not exert nonlinear optical effect to the diamond.

8. The process according to claim 1, wherein the authentication marking is invisible to naked eye and, wherein the authentication marking is preferably invisible to naked eye under magnification.

9. The process according to claim 1, wherein the authentication marking is invisible in reflection, transmission, or polarized observation method.

10. The process according to claim 1, wherein the authentication marking is optically visible under a fluorescence method, and wherein the authentication marking is represented by a darkened portion of an image of the diamond by contrast to the fluorescent background of the diamond.

11. The process according to claim 1, wherein the authentication marking is revealed from the part on/in diamond with no/low fluorescence in a predesigned pattern which is representative of the authentication marking.

12. A diamond having a non-removable authentication marking wherein the authentication marking is a non-optically detectable authentication marking in the diamond provided adjacent the outer surface of the diamond material having intrinsic optical centers, wherein the authentication marking is a predesigned authentication marking applied at a region of a diamond at or adjacent the surface of the diamond by way of a direct laser writing process using a pulsed laser having an effective laser wavelength range is from 300 nm to 400 nm, and wherein the fluorescence background of the diamond material from intrinsic optical center is suppressed by said marking under fluorescent imaging, such that the non-optically detectable authentication marking is viewable against the fluorescence background at the region of the diamond where the marking is applied and wherein the marking is non-removable.

13. A process of viewing a non-optically detectable authentication marking on a diamond, said process including the steps of:
(i) providing a diamond having an authentication marking applied thereto according to claim 1; and
(ii) viewing said diamond using a fluorescence imaging method;
wherein the diamond material has a fluorescence background from said intrinsic optical center and wherein said fluorescence background is suppressed by said marking under fluorescent imaging, such that the non-optically detectable authentication marking is viewable against the fluorescence background at the region of the diamond where the marking is applied.
